(19) United States
(12) Patent Application Publication
(10) Pub. No.: US 2026/0233978 A1
(43) Pub. Date: Aug. 13, 2026

(54) STS CRANE

(71) Applicant: Liebherr Container Cranes Ltd., Killarney, Co. Kerry (IE)

(72) Inventors: James SCANLON, Kilcummin (IE); David COUGHLAN, Killarney (IE)

(21) Appl. No.: 19/380,361

(22) Filed: Nov. 5, 2025

(30) Foreign Application Priority Data
Nov. 5, 2024 (DE) 10 2024 132 101.6

(51) Int. Cl. B66C 19/00

(52) U.S. Cl. CPC B66C 19/007

(57) ABSTRACT

The invention relates to an STS crane comprising: a gantry with four vertical legs, of which in each case two vertical legs are connected to one another by a sill beam; and an upper assembly with a boom as well as a front crossbeam and a rear crossbeam which carry the boom and in each case run transversely to the boom; wherein the upper assembly is fastened to the gantry via the front crossbeam and the rear crossbeam; characterized by at least one climbing device for vertically moving the front crossbeam or the rear crossbeam relative to the respective legs to which the crossbeam is fastened; and at least one climbing ladder extending on the legs in the vertical direction to cooperate with the climbing device.

### CROSS REFERENCE TO RELATED APPLICATION

The present application claims priority to German Patent Application No. 10 2024 132 101.6 filed on Nov. 5, 2024. The entire contents of the above-listed application are hereby incorporated by reference for all purposes.

### TECHNICAL FIELD

The present invention relates to an STS crane, in particular an STS crane with a system for rapid height adjustment of the upper assembly relative to the lower assembly, and to a method for assembling and operating such a crane.

### BACKGROUND

An STS crane (ship-to-shore crane) is a large port crane specially designed for loading and unloading container ships. It travels along the quay wall and lifts containers back and forth between the ship and the terminal. The cranes are capable of lifting containers precisely over large distances by operating with a trolley system that runs along a horizontal boom. Owing to their size and load-bearing capacity, STS cranes are of crucial importance for modern container handling in ports worldwide.

### SUMMARY

The present invention relates to a crane configured so that it can be assembled quickly and efficiently from a transport configuration into its working configuration, in particular taking into account space constraints and weather-related challenges during erection at the operating site.

In modern port logistics, speed and efficiency are of decisive importance, especially during the assembly and commissioning of STS cranes that are indispensable for handling containers on large cargo ships. These cranes play a central role in loading and unloading cargo and must be designed to be ready for operation quickly while meeting the highest safety standards. Delays or complications during assembly can lead to considerable economic losses and operational disruptions.

According to the prior art, various approaches are pursued to increase efficiency in the assembly of an STS crane. Thus, cranes are either fully assembled on site or delivered in a partially preassembled state to shorten assembly time. One example is the transport of crane parts or the entire crane on a ship with the upper assembly lowered to reduce the clearance height under bridges and to ensure stability during transport. This technique reduces structural loads due to swell and helps increase safety during transport.

However, these prior-art implementations also have disadvantages. Assembly in many cases requires special auxiliary devices, which increase complexity and space requirements. In addition, weather-related restrictions during assembly are a challenge, as unfavorable conditions can slow down or even interrupt the lifting and fastening processes required during completion of the crane assembly.

The present invention therefore aims to provide an improved and more efficient method for assembling the assemblies of an STS crane which enables quick assembly while minimizing weather-related restrictions, e.g. by making the assembly less susceptible to wind. The invention ensures that the crane can be brought quickly into its final working configuration after delivery, without requiring extensive additional equipment or large space requirements at the crane's operating site. The intention is to achieve a flexible and reliable solution for assembling STS cranes that meets the requirements of modern port logistics while ensuring high operational safety. This is achieved with an STS crane having the features described herein.

The invention describes an STS crane that comprises a gantry with four vertical legs, of which in each case two vertical legs are connected to one another by a sill beam, and an upper assembly with a boom as well as a front crossbeam and a rear crossbeam, which carry the boom and in each case run transversely to the boom, the upper assembly being fastened to the gantry via the front crossbeam and the rear crossbeam. The invention is further characterized by at least one climbing device for vertically moving the front crossbeam or the rear crossbeam relative to the respective legs to which the crossbeam is fastened, and by at least one climbing ladder extending on the legs in the vertical direction to cooperate with the climbing device.

By providing the climbing device on the STS crane, final assembly can be carried out with significantly less effort and also much more quickly. During transport of the partially assembled STS crane, the crossbeams on which the boom is mounted are not at their regular position at the upper end region of the legs, but are fastened in a lower region of the legs, typically at the level of the sill beams. After the partially assembled STS crane in transport configuration has been moved to its final location, it is therefore still necessary to raise the crossbeams carrying the boom to their position in the upper end region of the legs and fasten them there. As already described above, in the prior art the crossbeams were raised with the aid of auxiliary cranes, so that after moving the crossbeams into their final positioning in the upper end region of in each case two legs, they could be fixed there, e.g. by bolting.

According to the present invention, the provision of auxiliary cranes for lifting the crossbeams into their final positioning is no longer required, because the climbing device provided according to the invention and the climbing ladder provided on a respective leg can interact in such a way that, with an active climbing device, the crossbeam can move to its final positioning in the upper end region of the legs without the aid of an auxiliary crane. The climbing device is capable of moving the crossbeam successively upward along the climbing ladder, with a stable fastening between the crossbeam and the two legs between which the crossbeam is arranged being maintained during the climbing process. For this reason, lifting of the crossbeam or crossbeams is also possible under significantly worse weather or wind conditions, since wind action can never cause the crossbeam to sway or the like. The formerly greatly restricted weather window that had to be observed for lifting heavy loads is no longer relevant for the STS crane according to the present invention. Assembly to reach the working configuration is therefore possible even under significantly worse weather conditions and moreover without the auxiliary crane that was mandatory in the prior art, so that the time required to carry out the assembly as well as the space required for assembly according to the invention are significantly reduced.

According to an optional modification of the present invention, it can be provided that each of the four vertical legs is provided with a climbing ladder to cooperate with a respective climbing device.

Typically, there is a climbing ladder on each of the four legs of the gantry of the STS crane to provide engagement recesses into which the climbing device can engage.

According to a further advantageous refinement of the present invention, it can be provided that both the front crossbeam and the rear crossbeam have, at each of their longitudinal end regions, a climbing device that enables fastening to the respective adjacent leg with a variable position in the vertical direction.

It can thus be provided that each of the two crossbeams has, at its longitudinal end regions, a respective climbing device, so that a total of four climbing devices are present, each of the four climbing devices interacting with one of the four legs (or the climbing ladder arranged thereon) of the gantry.

According to a further refinement of the present invention, it can be provided that the at least one climbing device has two extendable pins spaced apart from one another in the vertical direction and a lifting actuator designed to vary the vertical spacing of the two pins.

The lifting actuator has a compressed state and an extended state and can thereby vary the vertical spacing of the two extendable pins. In interaction with a climbing ladder dimensioned accordingly and having a plurality of engagement recesses or pin recesses arranged one above the other in the vertical direction for inserting the pins, by a sequence of extending and retracting the pins in connection with compressing and extending the lifting actuator, the climbing device can effect movement in the vertical direction along the climbing ladder. For example, the lower pin is first brought into its extended position so that it interacts with an engagement recess of the climbing ladder. If the climbing device is then fixed by interaction of the pin with the engagement recess of the climbing ladder, the lifting actuator is moved from its compressed position into its extended position so that the upper pin can be inserted into a formerly overlying engagement recess of the climbing ladder. After extending the upper pin into the formerly overlying engagement recess of the climbing ladder, the climbing device is thus connected to the climbing ladder by both the lower pin and the upper pin. After reaching this state, the lower pin is withdrawn from its engagement recess of the climbing ladder, so that moving the lifting actuator into its compressed state results in the lower pin being pulled upward.

By arranging two pins spaced from one another in the vertical direction, whose vertical spacing is variable by means of a lifting actuator, the climbing device can climb upward or downward along the climbing ladder. The advantage here is that contact of the climbing device with the climbing ladder arranged on the leg is continuously maintained, so that movement of the climbing device or of the crossbeam carried by the climbing device and the elements fastened thereto can also be carried out under unfavorable weather or wind conditions.

According to an advantageous modification of the present invention, it can be provided that the lifting actuator is a hydraulic cylinder arrangement designed to generate relative movement of the two pins in the vertical direction.

Hydraulic cylinders have proven to be reliable and practical, in particular for lifting tasks with heavy weight, so that their use for lifting an upper crane assembly or a crossbeam relative to a pair of legs of a gantry of the STS crane is advantageous.

According to a further optional modification of the present invention, it can be provided that the two extendable pins are extendable and retractable orthogonally to the direction of movement of the climbing device and parallel to the longitudinal direction of the associated crossbeam. The climbing device is oriented relative to the crossbeam it carries such that the two pins extendable and retractable by the climbing device have a direction of movement that is aligned parallel to the longitudinal direction of the crossbeam. The crossbeam arranged between two legs of the gantry of the STS crane can therefore be fastened to the legs by the climbing device by means of the pins. The lifting actuator of the climbing device, by contrast, has a direction of movement that is orthogonal to the extension and retraction direction of the two pins.

According to an optional refinement of the present invention, it can be provided that on each of the four vertical legs the climbing ladder and the sill beam extending from the leg enclose a 90° angle in a plane normal to the vertical. The gantry of the STS crane is known to have four vertically oriented legs which, in a plan view, form the corners of a rectangle. Each of the four legs is connected to two adjacent legs (but not to a leg lying diagonally opposite) wherein a first connection to the first adjacent leg is formed via the sill beam and a second connection to the second adjacent leg via an end girder and a crossbeam. In addition, the two sill beams of the gantry lie opposite one another, which likewise applies to the two end girders and crossbeams.

According to a further advantageous embodiment of the present invention, it can be provided that the at least one climbing device has at least one sliding arrangement that serves to laterally fix the climbing device on the climbing ladder, so that only a sliding movement in the vertical direction is possible.

The sliding arrangement prevents possible lateral offset of the climbing device relative to the climbing ladder, so that the climbing device is only able to move in the vertical direction. This is particularly helpful in strong winds, because without the sliding arrangement the lateral force acting on the pin connection produced by the pins could become too great and, in particular during the climbing process, a skewed position between climbing ladder and climbing device could occur.

It can furthermore advantageously be provided that a first sliding arrangement and a second sliding arrangement are provided, and that the first sliding arrangement is arranged below a lower pin and the second sliding arrangement is arranged above an upper pin. By offsetting the two sliding arrangements in the vertical direction, it is ensured that the climbing device is laterally fixed to the climbing ladder at multiple points. This provides greater lateral stability.

According to a further advantageous refinement of the present invention, it can be provided that the climbing ladder is movable, relative to its respective vertical extent, in the vertical direction, but is restricted in its movement in the lateral directions, in particular rigid, by one or more guide plates that cooperate with a climbing-ladder guide, preferably with each of these climbing-ladder guides being fastened by a bolted or screwed connection to a base plate integrally projecting from a leg.

According to a further optional modification of the present invention, it can be provided that the at least one climbing device is detachably mounted on the associated crossbeam, preferably by means of a bolted connection.

In this context, for example, the at least one climbing device carrying the crossbeam, typically arranged at one of the longitudinal end regions of the crossbeam, can be detachably connected to the crossbeam itself, e.g. via bolted connections or the like. For this purpose, the crossbeam can have recesses in the region of its longitudinal ends for receiving bolted connections, e.g. on the side of the crossbeam facing the ground and/or on the adjacent side faces, which serve for a temporary connection with the climbing device.

This is advantageous because, after moving the crossbeam into its final positioning in the upper end region of the vertical legs and fixing it there, e.g. by means of bolted connections, the at least one climbing device that has moved the crossbeam upward into its final positioning is no longer needed and can be used elsewhere. For example, it is conceivable that the climbing devices are reused for moving different crossbeams of the same crane or of different cranes.

The invention further relates to a method for assembling an STS crane configured according to one of the aspects discussed above, wherein in the method the upper assembly of the STS crane is arranged in the lower half, preferably in the lower third, more preferably in the lower quarter of the vertical extent of the gantry in order to have the lowest possible center of gravity during a transport phase; after final placement of the STS crane, the upper assembly is moved upward relative to the gantry with the aid of the climbing device; and after the upper assembly reaches a working height, the front crossbeam and the rear crossbeam are fixed at their respective connections to the legs, in particular fixed by a bolted connection.

The method describes assembling the STS crane, which is capable of moving the crossbeams or the upper assembly of the crane, with the aid of a climbing device, from a lower section of the legs to an upper section of the legs. According to the method of the invention, the partially assembled STS crane is transported or moved to its final place of work in a state in which the crossbeams or the upper crane assembly are arranged in the lower half, preferably in the lower third, more preferably in the lower quarter of the legs of the STS crane. This lowers the center of gravity of the partially assembled STS crane and also reduces its transport height, which is advantageous in particular for passing under bridges when a partially assembled STS crane is loaded onto a ship.

Once the partially assembled STS crane has been moved to its final place of work, the first crossbeam and the second crossbeam, on which the boom of the STS crane is already mounted, are raised to their final working height with the aid of the climbing device.

Because lifting now requires no auxiliary crane, or even a plurality of auxiliary cranes, and the climbing of the crossbeam along the legs is also possible under significantly worse weather and wind conditions, the assembly time of the STS crane is significantly shorter and, moreover, less space is required.

According to a refinement of the method according to the invention, it can be provided that the at least one climbing device, for moving the associated crossbeam in the vertical direction, first brings the lower pin into engagement with a lower pin engagement of the climbing ladder arranged on the leg and then actuates the lifting actuator so that the upper pin is moved upward in the vertical direction in order to be able to interact with a formerly overlying pin engagement of the climbing ladder, preferably such that, after extending the upper pin to interact with the formerly overlying pin engagement, the lower pin is retracted and the lifting actuator is moved into its compressed position so that the lower pin is pulled upward.

By incrementally lifting the crossbeam and the permanent connection of the crossbeam to the two legs receiving the crossbeam via the movable pins, very high stability is achieved even during the climbing process.

According to a further advantageous modification of the invention, it can be provided that, after reaching a working height and fixing the crossbeams to the respective legs, in particular by a bolted connection, the at least one climbing device is dismantled from the crossbeam.

Dismantling the climbing device reduces the weight of the crossbeam and also ensures that the dismantled climbing device can be used to move another crossbeam.

According to a refinement of the present invention, it can be provided that the rear crossbeam and the front crossbeam are moved upward in the vertical direction simultaneously via their respective climbing devices or are moved upward in the vertical direction alternately, preferably such that, in alternating operation, the vertical height difference between the two crossbeams does not exceed the vertical spacing of two successive pin engagements on the climbing ladder.

It can furthermore be provided that the two climbing devices arranged on a crossbeam, each arranged at the two longitudinal end regions, are actuated simultaneously with respect to one another, so that the crossbeam remains horizontally aligned even during the climbing process. This further contributes to improving the stability of the STS crane during assembly. The invention also encompasses the case in which the two climbing devices of a crossbeam do not climb simultaneously but alternately.

### BRIEF DESCRIPTION OF THE FIGURES

Further features, details and advantages of the invention will be apparent from the following description of the figures. In the drawings:

FIG. 1A: a side view of an STS crane, in which the boom projecting to the left is designed to extend over the water beyond a quay wall,

FIG. 1B: a front view of an STS crane, in which the gantry travel mechanism for moving the crane parallel to the quay wall can also be seen,

FIG. 2: a side view of an upper assembly of an STS crane, which, inter alia, comprises the boom and the crossbeams,

FIG. 3: a side view of a lower assembly of an STS crane, which comprises the two vertical legs that are connected to one another by a sill beam,

FIG. 4: a side view of an STS crane according to the invention in a transport configuration in which the upper assembly is arranged in a lowered state on the legs,

FIG. 5: a perspective view of one of the four legs on which the crossbeam is arranged in its lowered state,

FIG. 6: a perspective view of the climbing device with its two extendable pins and the lifting actuator,

FIG. 7: a cross-section of the climbing device,

FIG. 8: a perspective view of a leg of the STS crane according to the invention with a climbing ladder, in which the associated crossbeam has already been moved into its final positioning, and

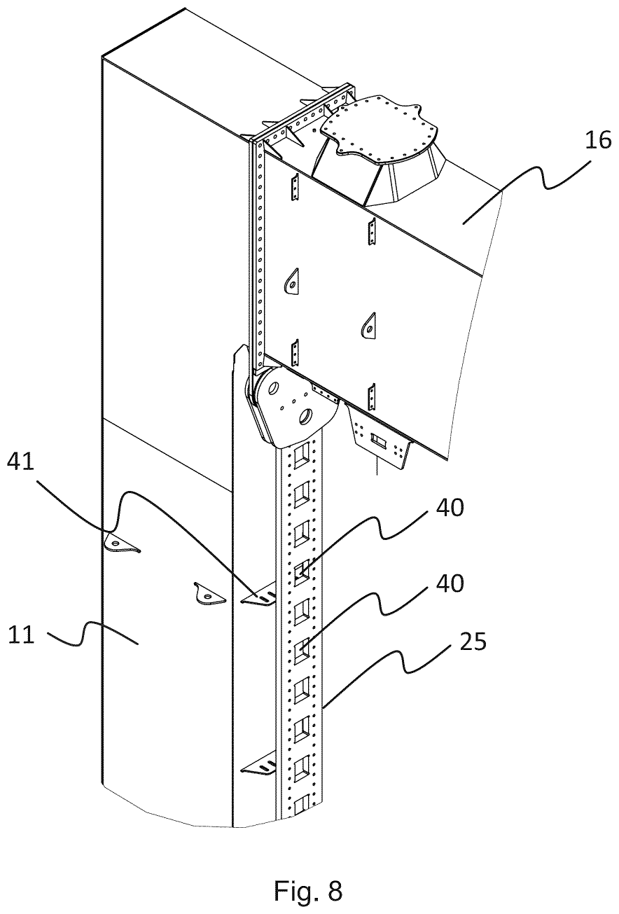

FIG. 9: a perspective view of a leg of the STS crane according to the invention, showing the connection of the climbing ladder to one of the vertical legs, which allows movement of the ladder in the vertical direction.

### DETAILED DESCRIPTION

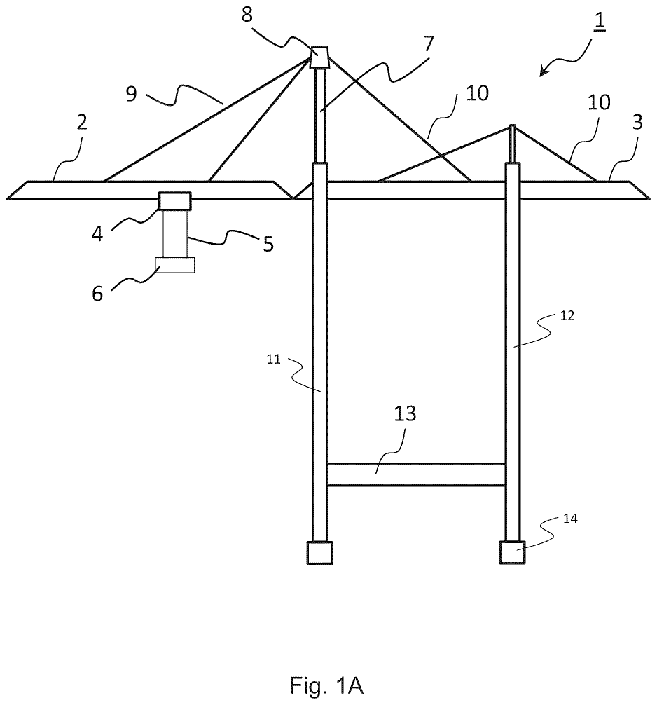

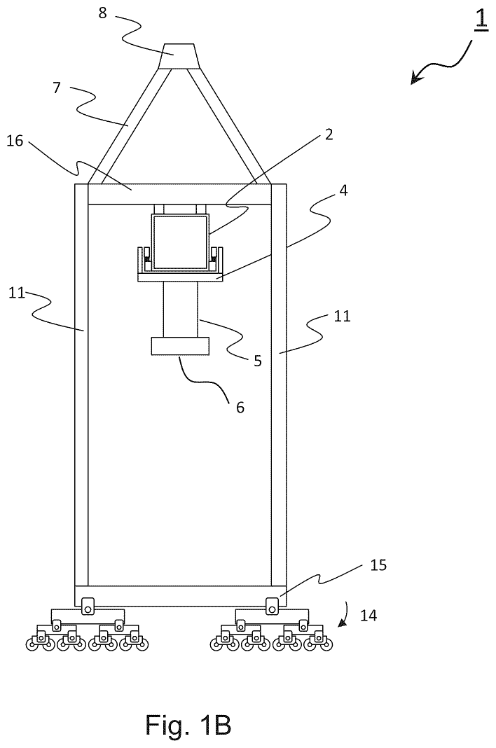

FIG. 1A shows a side view of an STS crane 1 which has a horizontally arranged boom 2 and back boom 3. The boom 2 and the back boom 3 are connected to one another so that the boom 2 can be folded upward relative to the back boom 3.

A trolley 4, movable in the longitudinal direction of the boom 2, is arranged on the boom 2, from which hoisting ropes 5 descend in order to vary the height of a spreader 6, a container spreader, fastened thereto.

The boom 2 is stayed by front stay cables 9 and the back boom 3 by rear stay cables 10, the stay cables 9 being guided via a head element 8 of the diagonal struts 7 (more clearly visible in FIG. 1B).

The boom 2, the back boom 3, the diagonal struts 7, the head element 8 and the associated stay cables 9, 10 are all supported by a front crossbeam 16 and a rear crossbeam which, in FIG. 1A, are concealed by the legs 11, 12 of the STS crane 1.

The STS crane 1 has a total of four vertically oriented legs 11, 12, namely two seaward legs 11 and two landward legs 12. In each case, a seaward leg 11 is connected to a landward leg 12 via a sill beam 13, which improves the stability of the gantry of the STS crane. At the end on the ground side, the legs 11, 12 each have a gantry travel mechanism 14 which serves to move the STS crane 1 parallel to the quay wall.

For this purpose, rails are typically provided parallel to the quay wall so that the gantry travel mechanism 14 can engage these rails with corresponding wheels and the crane 1 is movable parallel to the quay wall.

FIG. 1B shows a plan view of the STS crane 1 in which the design of the gantry travel mechanism 14 and of the end girder 15 connecting the two seaward legs can be clearly seen. It can be seen that the boom 2 is suspended from the front crossbeam 16 (and also from the concealed rear crossbeam) and that the diagonal struts 7 extend upward from the upper region of the respective longitudinal end regions of the crossbeam 16 to the head element 8. For the sake of clarity, the stay cables 9, the diagonal struts in the region of the rear crossbeam and the rear stay cables have not been shown.

It can be seen that the front crossbeam 16 (and also the rear crossbeam) in the fully assembled state of the STS crane 1 is fastened in each case to the upper end region of the vertical legs 11, 12.

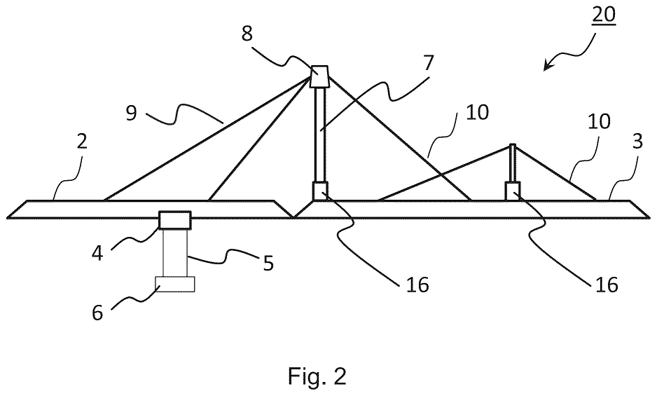

FIG. 2 shows a preassemblable assembly group, namely the upper assembly 20 of the STS crane 1, which comprises, for example, inter alia the crossbeams 16, the boom 2 and back boom 3 mounted hanging therefrom, the struts 7, the head element 8, the front stay cables 9 as well as the rear stay cables 10, the trolley 4 movable on the boom 2, and the spreader 6 descending therefrom.

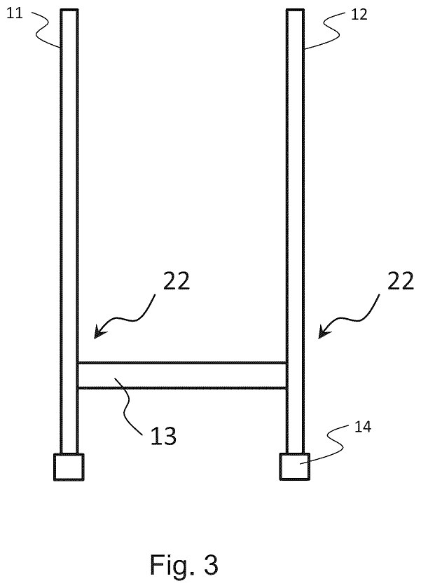

FIG. 3 shows the lower assembly 21 of the STS crane 1, which is likewise preassemblable and comprises, for example, inter alia the four legs 11, 12, the two sill beams 13, each of which connects a seaward leg 11 to a landward leg 12, the end girders 15, and the gantry travel mechanism 14 provided at the lower end of the respective four legs.

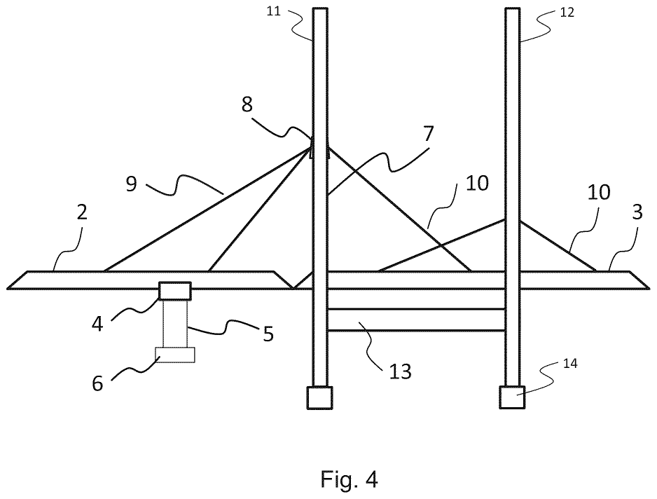

FIG. 4 shows a possible configuration of the preassembled STS crane 1 which is suitable for transport by sea. In this case, the upper assembly 20 of the STS crane 1 is arranged in a lower region of the legs 11, 12 and does not have the normal working height as would be the case in the fully assembled state. This may be necessary to reduce the maximum height of the STS crane 1 to be transported by sea and to permit passage under bridges or the like. Furthermore, this configuration is advantageous for transport by sea because the center of gravity is lower and the loads induced by swell are considerably lower.

According to the prior art, the upper assembly 20 of the crane is temporarily fastened in the lower region of the legs 11, 12 so that all components that are directly or indirectly fastened to the crossbeams are held safely for transport.

As already described above in the introductory part, after final placement of the STS crane 1 it is then necessary, according to the prior art, to release the temporary connections of the crossbeams to the legs 11, 12 and to raise the upper assembly 20 with the aid of auxiliary cranes in order to be able to fasten the crossbeams 16 in the upper end region of the legs 11, 12.

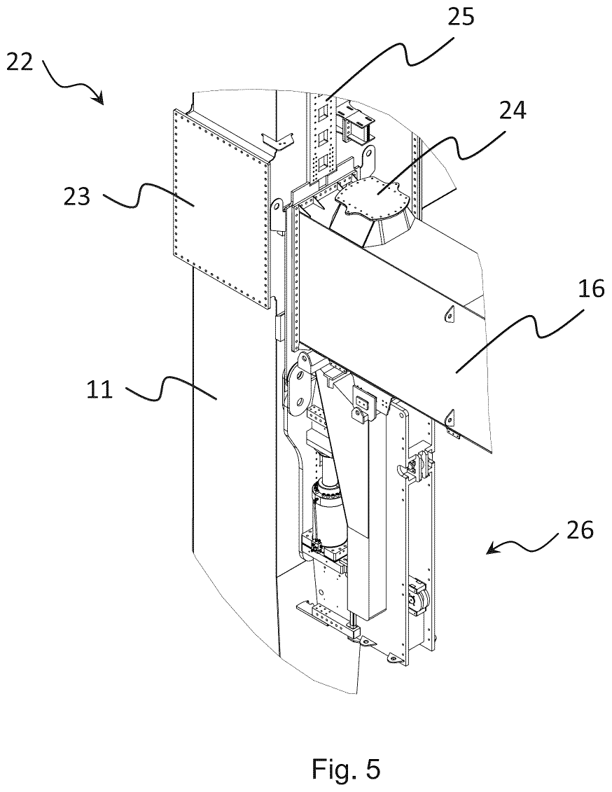

FIG. 5 shows a perspective view of the connection region of a crossbeam 16 with a leg 11 of an STS crane according to the invention, the crossbeam 16 being arranged in a lower region of the leg 11 so that transport in the configuration shown in FIG. 4 can be carried out.

Reference sign 23 denotes a sill-beam flange plate to which the sill beam 13 to the landward leg 12 is to be attached. For the sake of clarity, the sill beam 13 has not been shown. Furthermore, the strut 7 has also not been shown, only the strut flange plate 24, to which the strut 7 is attached, being visible.

It can be seen that the seaward leg 11 has, on the face oriented toward the other seaward leg 11, a climbing ladder 25 which extends parallel to the vertical direction of the leg 11; the crossbeam 16 is not in direct contact with the leg 11 but is instead connected to it via the climbing device 26. In the transport configuration, in which the upper assembly 20 of the STS crane 1 is in a lowered state, it can additionally be provided for extra security that the crossbeam 16 is fastened directly to the leg 11, for example by a bolted connection. The climbing device 26 engages, by means of movable pins, in pin engagements of the climbing ladder 25, which ensures secure fastening of the crossbeam 16 to the vertical leg 11 of the STS crane 1.

It is clear to the skilled person that the two longitudinal ends of a crossbeam 16 are arranged in the depicted manner on the facing region of the legs 11, 12. The same applies, of course, to the rear crossbeam, which is fastened in the same way.

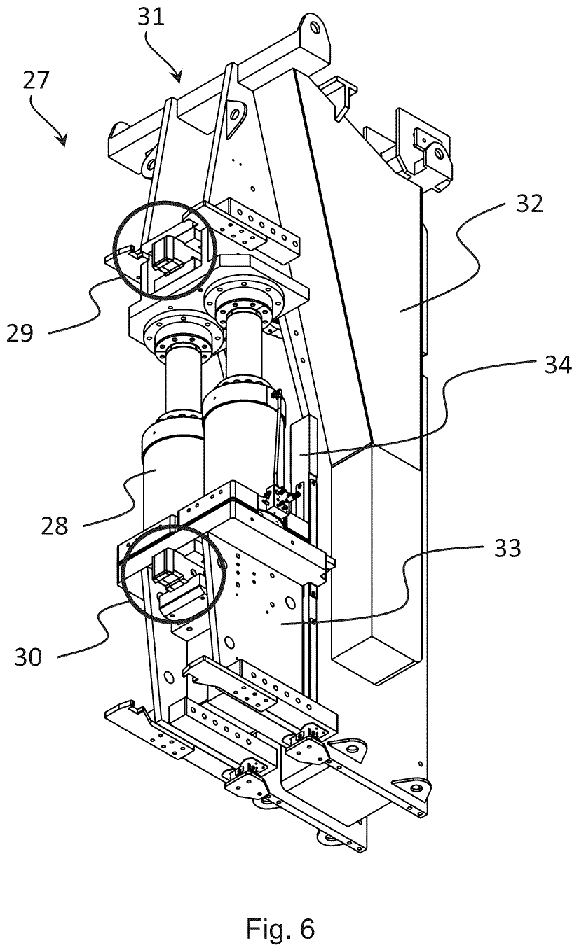

FIG. 6 shows a perspective view from below at an angle of the climbing device 26, in which the side 27 of the climbing device 26 facing the leg is particularly well visible.

The lifting actuator 28, for example implemented by one or more hydraulic cylinders, is capable of varying the relative spacing between an upper pin arrangement 29 and a lower pin arrangement 30. In order to allow movement only along a single axis, a guide 34 is provided that permits movement of a lower section 33 of the climbing device 26 relative to an upper section 32 of the climbing device 26 only along one axis, typically the vertical axis.

In addition, on the side of the climbing device 26 facing the leg, outwardly projecting sliding arrangements can be seen which serve to embrace the climbing ladder laterally so that only movement in the direction of the movement axis of the lifting actuator 28 is possible by the climbing device 26.

On the bearing surface 31 on the top side of the climbing device 26, the climbing device 26 supports a longitudinal end region of the crossbeam 16.

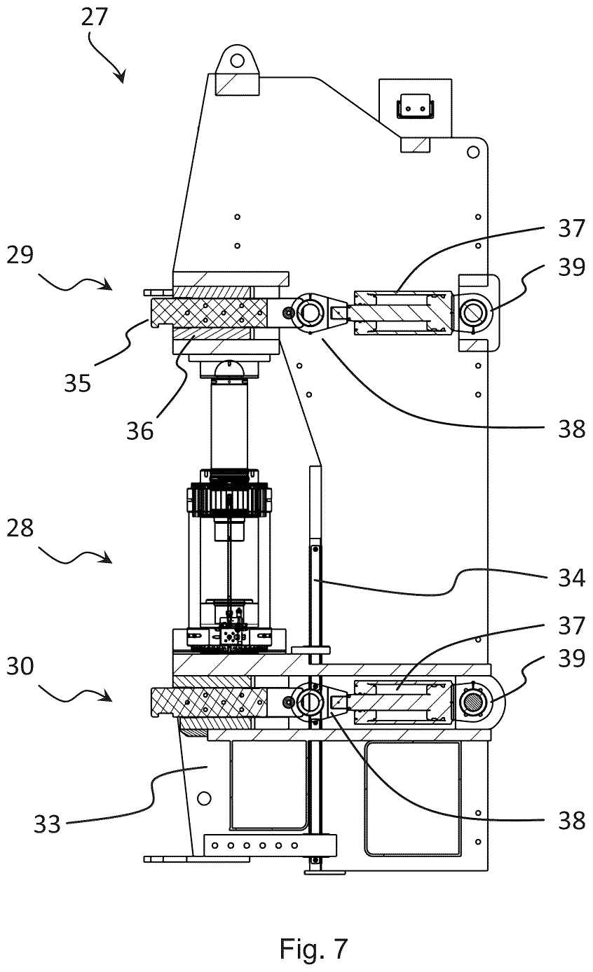

FIG. 7 shows a sectional view of the climbing device 26 and reveals a basic structure of the upper pin arrangement 29 and the lower pin arrangement 30. The lifting actuator 28, which is capable of varying the relative spacing of the two pin arrangements 29, 30, can also be seen.

The structure of the lower pin arrangement 30 is highly similar or identical to the structure of the upper pin arrangement 29. The pin 35 is extendable and retractable in a direction perpendicular to the movement direction of the lifting actuator 28 and, moreover, oriented toward the adjacent leg. A pin actuator 37 is provided for moving the pin 35, which can extend or retract the pin 35 along a pin guide 36. The pin actuator can be, for example, a hydraulic actuator; however, the fundamental inventive concept also encompasses any type of actuator, for example an electromechanical actuator.

The pin 35 and the pin actuator 37 are connected to one another via a connection 38, for example a fork-eye joint which, owing to possible torsion occurring in the climbing device 26, is advantageous because it can compensate for a skew between the actuator 37 and the pin 35.

The pin actuator 37 of the upper pin arrangement can likewise be fastened to the upper section 32 of the climbing device 26 via a corresponding connection 39, wherein a fork-eye joint can also be provided here. The same applies to the lower pin arrangement.

With the climbing device 26 shown, it is possible to allow the upper assembly 20 of the STS crane 1, arranged in a lower region of the legs, to climb upward into its final working position. In the final working position, the crossbeams 16 are then located in the upper end region of the legs, so that the top side of the crossbeams 16 is flush with the top side of the legs. In such a positioning, the crossbeam can then be permanently fastened by means of bolted connections.

The climbing of the crossbeam from the lower arrangement position to its upper final working height is carried out by coordinated actuation of the upper and lower pin arrangements 29, 30 and of the lifting actuator 28. The pins 35 of the pin arrangements 29, 30 spaced apart from one another engage in succession in pin recesses 40 of the climbing ladder 25, so that extension and retraction of the lifting actuator results in incremental lifting of the climbing device and thus of the crossbeam 16 carried by the climbing device 26.

In certain embodiments and with respect to at least one or to each of the climbing ladders 25 and respective vertical legs, it may be advantageous if the climbing ladder 25 can perform a vertical movement relative to the vertical leg in the direction of the lower region of the vertical leg, while the climbing ladder is fixed in the lateral direction (i.e. perpendicular to the vertical direction) or its freedom of movement is clearly restricted.

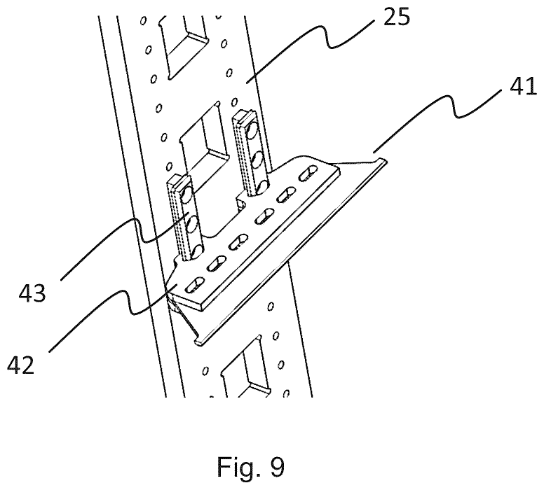

With reference to FIG. 9, at least one assembly comprising a base plate 41, guide plate 42 and climbing-ladder guide 43 can be arranged between the opposing faces of each climbing ladder 25 and its respective vertical leg 11, 12, with each of the at least one assemblies satisfying the following: the base plate can be an integral part of the vertical leg, the guide plate can be fastened to the leg plate by means of a preferably detachable connection and/or the climbing-ladder guide can be fastened to the climbing ladder 25. The guide plate 42 can be configured with respect to the climbing-ladder guide 43 such that extension of the climbing ladder relative to the vertical leg is possible, but lateral movement is prevented.

The climbing process can be described by the sequence of the steps listed below:
1. The pin 35 of the upper pin arrangement 29 is initially fully retracted so that it is not in engagement with a pin recess 40 of the climbing ladder 25.
2. The pin 35 of the lower pin arrangement 30 is extended and engages in a first pin recess 40 of the climbing ladder 25.
3. The lifting actuator 28 is actuated so that the spacing between the lower pin arrangement 30 and the upper pin arrangement 29 increases. Together with the upper pin arrangement 29, the upper section 32 of the climbing device also moves upward, a guide 34 to the lower section 33 restricting the relative movement of the two sections and permitting only movement in the actuation direction of the lifting actuator 28.
4. The pin of the upper pin arrangement 29 is extended and engages in a pin recess 40 of the climbing ladder 25, so that at this point both the lower pin and the upper pin engage in a respective pin recess 40 of the climbing ladder 25.
5. The pin of the lower pin arrangement 30 is withdrawn from its pin recess 40 so that it is no longer in engagement with a pin recess 40 of the climbing ladder 25. The climbing device is now secured to the leg only by the pin of the upper pin arrangement 29.
6. The lifting actuator is moved into its compressed state so that the lower section 33 of the climbing device is pulled upward. Again, the guide 34 ensures pulling upward fixed in its direction.
7. After complete retraction of the lifting actuator 28, the pin of the lower pin arrangement 30 is extended again so that it can engage in a formerly overlying pin recess. At this time, again both pins are inserted into a respective pin recess of the climbing ladder 25.
8. The pin of the upper pin arrangement 29 is withdrawn so that the sequence of the steps set out can begin again.

It is clear to the skilled person that the prescribed sequence applies to each of the four climbing devices, wherein it can be provided that several climbing devices, in particular all four climbing devices, are actuated in synchronized fashion so that the crossbeam remains continuously horizontal during a climbing process. It is also possible, when a plurality of climbing devices are present, to have the individual climbing devices perform a respective climbing step one after the other before another climbing device follows with its associated climbing step. Slight skewing of a crossbeam may then occur; however, these may be acceptable, in particular when the spacing of the individual pin recesses is not too great.

It can furthermore be provided that the guide 34 or also the connections 38, 39, which can be implemented as joint connections, have polymer composite bearings. It can further be provided that the guide 34 has ball-bearing or roller-bearing elements and a recirculation system.

The present invention therefore makes it possible to carry out rapid assembly of an STS crane that is partially preassembled in the transport configuration, which is furthermore executable without the use of an auxiliary crane and within a significantly broader weather window.

### LIST OF REFERENCE SIGNS

1 STS crane (ship-to-shore crane)
2 Boom
3 Back boom
4 Trolley
5 Hoisting ropes
6 Spreader (container spreader)
7 Struts
8 Head element
9 Stay cables
10 Rear stay cables
11 Seaward legs
12 Landward legs
13 Sill beam
14 Gantry travel mechanisms
15 End girder
16 Beam or transport carriage
20 Upper assembly of the STS crane
21 Lower assembly of the STS crane
22 Lower position on the legs
23 Sill-beam flange plate
24 Strut flange plate
25 Climbing ladder
26 Climbing device
27 Side face of the climbing device
28 Lifting actuator
29 Upper pin arrangement
30 Lower pin arrangement
31 Bearing surface
32 Upper section of the climbing device
33 Lower section of the climbing device
34 Guide
35 Pin
36 Pin guide
37 Pin actuator
38 Pin connection
39 Pin-actuator connection
40 Receiving recess/pin engagement of the climbing ladder

1. An STS crane, comprising:
a gantry with four vertical legs, of which in each case two vertical legs are connected to one another by a sill beam,
an upper assembly with a boom as well as a front crossbeam and a rear crossbeam which carry the boom and in each case run transversely to the boom, wherein the upper assembly is fastened to the gantry via the front crossbeam and the rear crossbeam,
at least one climbing device for vertically moving the front crossbeam or the rear crossbeam relative to the respective legs to which the crossbeam is fastened, and
at least one climbing ladder extending on the legs in the vertical direction to cooperate with the climbing device.

2. The STS crane according to claim 1, wherein each of the four vertical legs is provided with a climbing ladder to cooperate with a respective climbing device.

3. The STS crane according to claim 1, wherein both the front crossbeam and the rear crossbeam have, at each of their longitudinal end regions, a climbing device which enables a variable fastening in the vertical direction to the respective adjacent leg.

4. The STS crane according to claim 1, wherein the at least one climbing device has at least two extendable pins spaced apart from one another in the vertical direction and at least one lifting actuator configured to vary the vertical spacing of the two pins.

5. The STS crane according to claim 4, wherein the at least one lifting actuator is a hydraulic cylinder arrangement configured to produce a relative movement of the two pins in the vertical direction.

6. The STS crane according to claim 4, wherein the two extendable pins are extendable and retractable orthogonally to the direction of movement of the climbing device and parallel to the longitudinal direction of the associated crossbeam.

7. The STS crane according to claim 1, wherein, on each of the four vertical legs, the climbing ladder and the sill beam extending from the leg enclose a 90° angle in a plane normal to the vertical.

8. The STS crane according to claim 1, wherein the at least one climbing device has at least one sliding arrangement that serves to laterally fix the climbing device on the climbing ladder so that only a sliding movement in the vertical direction is possible.

9. The STS crane according to claim 8, wherein the at least one sliding arrangement comprises a first sliding arrangement and a second sliding arrangement, and wherein the first sliding arrangement is arranged below a lower pin and the second sliding arrangement is arranged above an upper pin.

10. The STS crane according to claim 1, wherein:
the climbing ladder is movable, relative to its respective vertical extent, in the vertical direction, but in the lateral directions is restricted in its movement by one or more guide plates that cooperate with a climbing-ladder guide.

11. The STS crane according to 1, wherein the at least one climbing device is detachably attached to the associated crossbeam.

12. A method for assembling the STS crane according claim 4, wherein in the method:
the upper assembly of the STS crane is arranged in a lower half of the vertical extent of the gantry, in order to have the lowest possible center of gravity during a transport phase;
after final placement of the STS crane, the upper assembly is moved upward relative to the gantry with the aid of the climbing device; and
after the upper assembly reaches a working height, the front crossbeam and the rear crossbeam are fixed at their respective connections to the legs.

13. The method according to claim 12, wherein the at least one climbing device, for moving the associated crossbeam in the vertical direction, first brings a lower pin of the at least two extendable pins into engagement with a lower pin engagement of the climbing ladder arranged on the leg and then actuates the lifting actuator so that an upper pin of the at least two extendable pins is moved upward in the vertical direction in order to be able to interact with a formerly overlying pin engagement of the climbing ladder.

14. The method according to claim 12 wherein, after reaching a working height and fixing the crossbeams to the respective legs, the at least one climbing device is dismantled from the crossbeam.

15. The method according to claim 12, wherein the rear crossbeam and the front crossbeam are moved upward in the vertical direction simultaneously via their respective climbing devices or are moved upward in the vertical direction alternately, wherein, in alternating operation, the vertical height difference between the two crossbeams does not exceed the vertical spacing of two successive pin engagements on the climbing ladder.

16. The STS crane according to claim 10, wherein each of these climbing-ladder guides is fastened, by a connection to a base plate integrally projecting from a leg.

17. The STS crane according to claim 16, wherein the connection is a bolted or screwed connection.

18. The STS crane according to claim 11, wherein the at least one climbing device is detachably attached to the associated crossbeam by means of a bolted connection.

19. The method according to claim 12, wherein the upper assembly of the STS crane is arranged in a lower third of the vertical extent of the gantry.

20. The method according to claim 12, wherein the front crossbeam and the rear crossbeam are fixed at their respective connections to the legs by a bolted connection.
